(19) United States
(12) Patent Application Publication
(10) Pub. No.: US 2024/0067150 A1
(43) Pub. Date: Feb. 29, 2024

(54) A BRAKING SYSTEM AND METHOD FOR OPERATING A BRAKING SYSTEM

(71) Applicant: Continental Teves AG & Co. OHG, Frankfurt am Main (DE)

(72) Inventor: Aleksandar Stanojkovski, Kleinostheim (DE)

(73) Assignee: Continental Teves AG & Co. OHG, Frankfurt am Main (DE)

(21) Appl. No.: 17/767,402

(22) PCT Filed: Oct. 6, 2020
(86) PCT No.: PCT/EP2020/077923

§ 371 Date: Apr. 7, 2022

(30) Foreign Application Priority Data
Oct. 8, 2019 (DE) 10 2019 215 360.7

(51) Int. Cl. B60T 13/74; B60T 8/40; B60T 8/88

(52) U.S. Cl. CPC B60T 13/745; B60T 8/4081; B60T 8/88; B60T 2270/402

(57) ABSTRACT

A brake system comprises a linear actuator and a pump. A first brake circuit has a first plurality of wheel connections connected thereto. A second brake circuit has a second plurality of wheel connections connected thereto. An electronic control device is configured to execute instructions for electively applying pressure to the first brake circuit with the pump and selectively applying pressure to the second brake circuit with the linear actuator. A method for operating a brake system for a motor vehicle comprises selectively applying pressure is to a first brake circuit with a pump and selectively applying pressure to a second brake circuit with a linear actuator.

### CROSS-REFERENCE TO RELATED APPLICATIONS

This U.S. patent application claims the benefit of PCT patent application No. PCT/EP2020/077923, filed Oct. 6, 2020, which claims the benefit of German patent application No. 10 2019 215 360.7, filed Oct. 8, 2019, both of which are hereby incorporated by reference.

### TECHNICAL FIELD

The invention relates to a brake system and a method for operating a brake system for a motor vehicle.

### BACKGROUND

Brake systems are commonly used in motor vehicles in order to decelerate these in a targeted manner. Brake systems are typically divided into multiple brake circuits in order to have redundancy available in the event of failure of one brake circuit. Present-day brake systems commonly not only have a master brake cylinder, by means of which a driver can generate hydraulic pressure directly, but furthermore also have electrical pressure generators such as linear actuators or pumps.

If parts of a brake system fail, the question arises as to the extent to which the brake system can at least partially maintain its functionalities.

It is therefore, desirable to provide a system and a method for operating a brake system for a motor vehicle, which can at least partially maintain braking functionalities in the event of failure of a brake circuit.

### SUMMARY

A method for operating a brake system for a motor vehicle is provided herein. The brake system has a linear actuator and a pump. The brake system has a multiplicity of wheel connections. The brake system has a first brake circuit to which associated wheel connections are connected. The brake system has a second brake circuit to which associated wheel connections are connected.

The method provides for selectively applying pressure to the first brake circuit by means of the pump, and selectively applying pressure to the second brake circuit by means of the linear actuator.

The pressure can be applied to the two brake circuits independently of one another by means of the pump or the linear actuator respectively. This allows a purely electrical application of pressure, and separate actuation of the two brake circuits, even in the event of a partial failure of components of the brake system. Therefore, pressure can be applied to the two brake circuits simultaneously.

Thus, it is possible to avoid the need for pressure to be applied to one of the brake circuits by means of a master brake cylinder, which would be more difficult to control.

The linear actuator may for example be a discontinuously conveying device that can be charged with brake fluid and then release the brake fluid in a controlled manner. The pump may for example be a piston pump, which may for example be a continuously conveying pump.

For example, two wheel connections may be connected to each brake circuit. It is however also possible for one wheel connection or more than two wheel connections to be connected to a respective brake circuit.

The wheel connections associated with the first brake circuit may for example be assigned to a front axle. The wheel connections associated with the second brake circuit may for example be assigned to a rear axle. This allows for a front/rear split of a brake system. Other embodiments are however also possible here, for example, a diagonal split.

The first brake circuit and the second brake circuit may be switchably connected to one another for example by means of at least one circuit separating valve. The circuit separating valve may for example be closed during the method. This allows a separation of the two brake circuits such that a respective pressure can be built up and set in a mutually independent manner. However, if the two brake circuits need to be connected in other operating modes, the circuit separating valve can be opened.

The brake system may have a master brake cylinder, wherein the master brake cylinder may be hydraulically decoupled from the brake circuits during the method. By means of such a master brake cylinder, it is for example possible for a driver braking demand to be detected and for a brake pressure to be built up accordingly. Fallback operation in the event of a failure of all electrical components can also be implemented using such a master brake cylinder. However, during the execution of the method, a pressure build-up by means of a master brake cylinder is typically not necessary.

The brake system may for example have a simulator, wherein the master brake cylinder may be hydraulically connected exclusively to the simulator during the method. In this way, a pressure generated by the master brake cylinder can be diverted into the simulator, and the driver can thus be provided with feedback.

The first brake circuit and the second brake circuit may be hydraulically separated from one another during the method. This allows separate pressure setting.

Circuit-specific pressure control may be performed by means of the pump and/or the linear actuator. A separate pressure can thus be set for each of the two brake circuits. If the brake circuits are assigned to respective axles, the circuit-specific pressure control may also be axle-specific pressure control.

The brake system may have at least one first module and one second module that is structurally separate therefrom. For example, the linear actuator may be arranged in the first module and the pump may be arranged in the second module. This allows a split into two modules, wherein the module with the pump may for example be a module for highly autonomous driving. Other arrangements of the components, for example an arrangement of all of the components in one module, are however also possible. A module may for example be understood as a block.

In one embodiment, the brake system has at least one electronic control device, wherein the method is executed in response to a total failure or partial failure of the electronic control device. In this way, such a failure can be reacted to in a suitable manner. Therefore, by way of the method, part of a functionality can be maintained which at least allows separate pressure control and automatic pressure generation in both brake circuits.

The linear actuator may also be configured and/or used for active pressure reduction in the second brake circuit. This makes it possible to not only increase the pressure but also to actively reduce it. For this purpose, brake fluid may for example be drawn from the second brake circuit into the linear actuator.

In one embodiment, the brake system has a number of one or more valves in the first brake circuit. All the valves in the first brake circuit between the pump and associated wheel connections may for example be modulatable. This allows pressure control to be performed. In a simple case, said valves may also be open, for example for a certain period of time.

In one embodiment, the brake system has a number of one or more valves in the second brake circuit. All the valves in the second brake circuit between the linear actuator and associated wheel connections may for example be modulatable. This allows individual pressure control to be performed. In a simple case, said valves may also be open.

The brake system may have a fluid reservoir, wherein, for example, the pump and/or the linear actuator may be connected at the suction side to the fluid reservoir. This allows a straightforward replenishment of brake fluid by suction, which brake fluid can be used for the build-up of pressure.

The brake system may have a linear actuator, a pump, and a multiplicity of wheel connections. The brake system has a first brake circuit to which associated wheel connections are connected. The brake system has a second brake circuit to which associated wheel connections are connected. Furthermore, the brake system has an electronic control device which is configured to execute a method

The motor vehicle may have a first front wheel with a first front wheel brake and a second front wheel with a second front wheel brake. The motor vehicle may furthermore have a first rear wheel with a first rear wheel brake and a second rear wheel with a second rear wheel brake. The front wheel brakes may be connected to the wheel connections associated with the first brake circuit. The rear wheel brakes may be connected to the wheel connections associated with the second brake circuit.

The functionality of the brake system may be used for example by such a motor vehicle. In this case, pressures at the front axle and rear axle can be electrically generated independently of one another, and these pressures can also be set independently of one another. However, it should be understood that other connection configurations, for example a diagonal split, are also possible.

A non-volatile, computer-readable storage medium is provided on which program code is stored, during the execution of which a processor executes instructions to execute the method

With the method, it is for example possible to counteract the problem whereby only a limited pedal force is available if a master brake cylinder is used for the build-up of pressure at one of the brake circuits. The pedal and the brake circuits can ultimately be separated from one another. Thus, the pedal feel remains unchanged. An electronic brake force distribution capability is provided.

### BRIEF DESCRIPTION OF THE DRAWINGS

Further features and advantages will be found by a person skilled in the art from the exemplary embodiments described below with reference to the appended drawing, in which:

FIG. 1 shows a schematic configuration of pressure generators and brake circuits; and

FIG. 2 shows a brake system.

### DETAILED DESCRIPTION

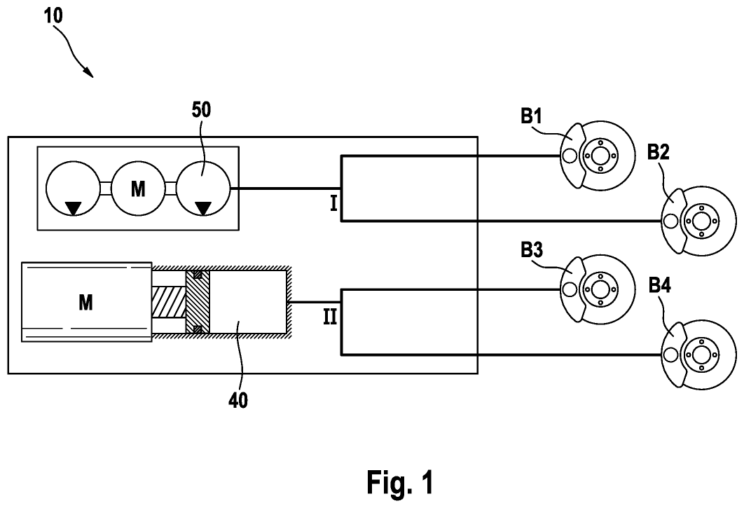

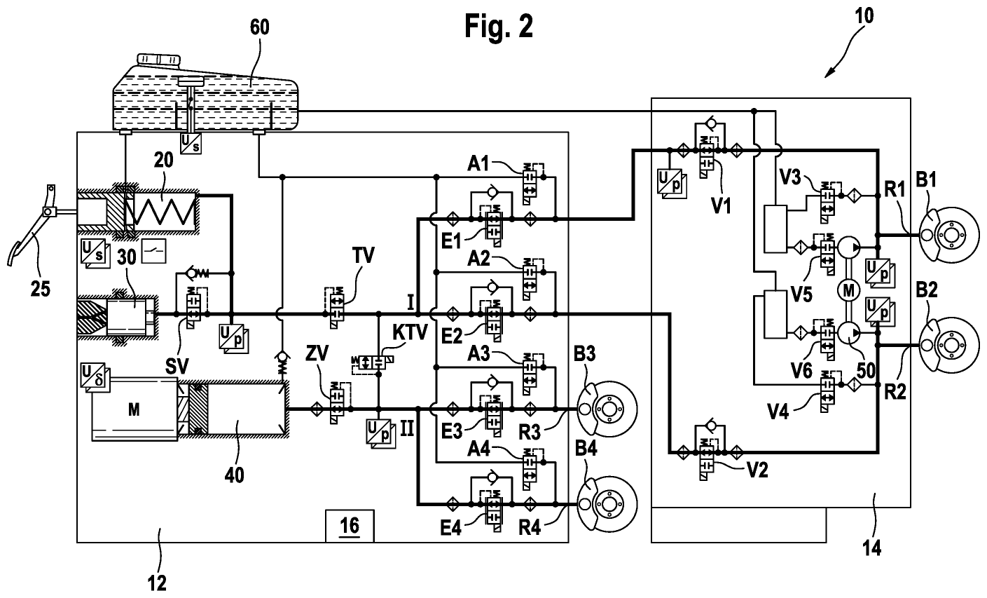

FIG. 1 shows, purely schematically, components of a brake system 10 according to an exemplary embodiment of the invention. Further components are illustrated in FIG. 2.

The brake system 10 has a linear actuator 40 and a pump 50. The linear actuator 40 constitutes a discontinuously conveying system. The pump 50 is configured as a continuously conveying piston pump. Both the linear actuator 40 and the pump 50 are driven by a respectively dedicated motor M.

The brake system 10 has a first brake circuit I and a second brake circuit II. As shown, the first brake circuit I is connected to the pump 50 in the present case. By contrast, the second brake circuit II is connected to the linear actuator 40. There is no connection between the two brake circuits I, II in the circuit configuration shown. A total of four wheel brakes, namely a first wheel brake B1, a second wheel brake B2, a third wheel brake B3 and a fourth wheel brake B4, are connected to the brake system 10. The first and second wheel brakes B1, B2 are connected to the first brake circuit I. The third and fourth wheel brakes B3, B4 are connected to the second brake circuit II. An individual pressure can thus be set for the first and second brakes B1, B2 independently of the third and fourth brakes B3, B4, or in other words, a respective individual pressure can be generated and set purely electrically at the two brake circuits I, II with the respectively connected wheel brakes B.

FIG. 2 shows the brake system 10 in more detail and with further components.

As shown, the brake system 10 is divided into a first module 12 and a second module 14. The modules 12, 14 may also be referred to as blocks. For the control of the brake system 10, an electronic control device 16 is provided which is configured to carry out a method. Further control tasks are also performed by the control device 16. The second module 14 furthermore has an independent control device, which is referred to as MK100 HBE ECU.

The first module 12 is a standard brake system, which could also be used on its own. The second module 14 is an additional module for highly autonomous driving, in which an additional pump 50 is provided which at least partially ensures operation of the brake system 10 even in the event of a failure of components of the first module 12.

As shown, the brake system 10 has a master brake cylinder 20 with a brake pedal 25 connected thereto. This enables a driver to communicate a braking demand and also to build up a brake pressure in a hydraulic fallback level situation. The brake system 10 has a simulator 30 that is connected to the master brake cylinder 20 via a simulator valve SV. The master brake cylinder 20 and simulator 30 are connected to the other hydraulic components via a separating valve TV. In a normal braking mode, the simulator valve SV is open and the separating valve TV is closed, such that the master brake cylinder 20 is connected only to the simulator 30 and a driver thus feels a force that is generated by the simulator 30. There is no direct hydraulic action; instead, a driver braking demand is detected by means of an installed travel sensor U/s and/or by means of a pressure sensor U/p. The driver braking demand is then implemented automatically, specifically by means of the linear actuator 40 and the pump 50.

The two brake circuits I, II are connected to one another by means of a circuit separating valve KTV. This allows a pressure equalization when the circuit separating valve KTV is open and separation of the two brake circuits when the circuit separating valve KTV is closed. The second brake circuit II is connected to the linear actuator 40 via a sequence valve ZV.

The brake system 10 furthermore has a fluid reservoir 60, which is configured as a conventional brake fluid vessel. This is used in particular as a return and for providing a supply to the fluid-consuming components. This will not be discussed in any more detail, because these are known embodiments.

The first and second wheel brakes B1, B2 are connected to first and second wheel connections R1, R2 of the second module 14. These are connected to inlet valves E1, E2 and outlet valves A1, A2 of the first module 12. They can thus be actuated from the first module 12 and have pressure applied thereto by the pump 50 of the second module 14. In the second module 14, there are also a total of six valves V1, V2, V3, V4, V5, V6, which will not be discussed in any more detail here.

The third and fourth wheel brakes B3, B4, on the other hand, are connected directly to third and fourth wheel connections R3, R4 of the first module 12, specifically to respective inlet valves E3, E4 and outlet valves A3, A4, as shown.

If pressure is to be applied electrically to both brake circuits I, II independently of one another, the separating valve TV can first be closed in order to prevent a direct onward transmission of a pressure generated by the driver. The circuit separating valve KTV is likewise closed in order to prevent a pressure equalization between the two brake circuits I, II.

Pressure is applied to the first brake circuit I by means of the pump 50. For this purpose, the valves V1, V2, V3, V4, V5, V6 of the second module 14 are switched in a suitable manner. Pressure is applied to the second brake circuit II by means of the linear actuator 40. Thus, pressure is electrically applied to the two brake circuits I, II independently of one another. A corresponding setting of the pressure is also possible.

This mode of operation may be selected for example in the event of a partial failure of components of the brake system 10, if the components required for this are still available. If, for example, the first and second wheel brakes B1, B2 are associated with a different axle than the third and fourth wheel brakes B3, B4, axle-specific setting is thus possible. Circuit-specific setting can otherwise be spoken of. This makes it possible, for example, to maintain the functionality of an electronic brake force distribution even in the event of a partial failure of the brake system 10.

The mentioned steps of the method may be executed in the sequence indicated. However, they may also be executed in a different order, if this is technically appropriate. In one of its embodiments, for example with a specific combination of steps, the method may be executed in such a way that no further steps are executed. However, in principle, further steps may also be executed, even steps that have not been mentioned.

It is pointed out that features may be described in combination in the claims and in the description, for example in order to facilitate understanding, even though these may also be used separately from one another. A person skilled in the art will recognize that such features may also independently of one another be combined with other features or feature combinations.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1-16. (canceled)

17. A method for operating a brake system for a motor vehicle comprising:
selectively applying pressure to a first brake circuit with a pump; and
selectively applying pressure to a second brake circuit with a linear actuator.

18. The method as claimed in claim 17, wherein the pump is a piston pump.

19. The method as claimed in claim 17, wherein the first brake circuit and the second brake circuit are switchably connected to one another with at least one circuit separating valve, and wherein the circuit separating valve is closed while selectively applying pressure to the first and second brake circuit.

20. The method as claimed in claim 17, further comprising hydraulically decoupling a master brake cylinder from the first and second brake circuits while selectively applying pressure to the first and second brake circuit.

21. The method as claimed in claim 20, further comprising hydraulically connecting the master brake cylinder exclusively to a simulator while selectively applying pressure to the first and second brake circuit.

22. The method as claimed in claim 17, wherein the first brake circuit and the second brake circuit are hydraulically isolated from one another while selectively applying pressure to the first and second brake circuit.

23. The method as claimed in claim 17, further comprising performing a circuit-specific pressure control with one of the pump and the linear actuator.

24. The method as claimed in claim 17, further comprising arranging the linear actuator in at least one first module and arranging the pump in a second module, wherein the at least one first module and the second module are structurally separate from one another.

25. The method as claimed in claim 17, wherein selectively applying pressure to the first and second brake circuit is in response to one of a total failure and partial failure of an electronic control device.

26. The method as claimed in claim 17, further comprising actively reducing pressure in the second brake circuit with the linear actuator.

27. The method as claimed in claim 17, further comprising modulating at least one of a plurality of valves between the pump and associated wheel connections of the first brake circuit.

28. The method as claimed in claim 17, further comprising modulating at least one of a second plurality of valves between the linear actuator and associated wheel connections in the second brake circuit.

29. The method as claimed in claim 17, wherein at least one of the pump and the linear actuator are connected at a suction side to a fluid reservoir.

30. The method as claimed in claim 17, further comprising a non-volatile, computer-readable storage medium on which program code is stored, during the execution of which a processor executes instructions for selectively applying pressure to the first and second brake circuit.

31. A brake system comprising:
a linear actuator;
a pump;
a first brake circuit, wherein a first plurality of wheel connections are connected thereto;
a second brake circuit, wherein a second plurality of wheel connections are connected thereto; and
an electronic control device configured to execute instructions for:
selectively applying pressure to the first brake circuit with the pump; and
selectively applying pressure to the second brake circuit with the linear actuator.

32. The brake system as claimed in claim 31, further comprising:
a first front wheel with a first front wheel brake and a second front wheel with a second front wheel brake;
a first rear wheel with a first rear wheel brake and a second rear wheel with a second rear wheel brake;
wherein the first and second front wheel brakes are connected to the first plurality of wheel connections;
wherein the first and second rear wheel brakes are connected to the second plurality of wheel connections.

33. The brake system as claimed in claim 31, wherein the pump is a piston pump.

34. The brake system as claimed in claim 31, wherein the first brake circuit and the second brake circuit are switchably connected to one another with at least one circuit separating valve, and wherein the circuit separating valve is closed while selectively applying pressure to the first and second brake circuit.

35. The brake system as claimed in claim 31, wherein the master brake cylinder is hydraulically decoupled from the first brake circuit while selectively applying pressure to the first brake circuit, and is hydraulically decoupled from the second brake circuit while selectively applying pressure to the second brake circuit.

36. The brake system as claimed in claim 31, wherein the first brake circuit and the second brake circuit are hydraulically isolated from one another while selectively applying pressure to the first and second brake circuit.
